(19) United States
(12) Patent Application Publication
(10) Pub. No.: US 2006/0160045 A1
(43) Pub. Date: Jul. 20, 2006

(54) Local and residual application system for in intra-oral medications

(76) Inventor: Victor Enrique Montangero, Buenos Aires (AR)

Correspondence Address: DEFILLO & ASSOCIATES, INC., 4922 EAGLE COVE SOUTH DRIVE, PALM HARBOR, FL, 34685, US

(21) Appl. No.: 11/315,515

(22) Filed: Dec. 22, 2005

(30) Foreign Application Priority Data
Dec. 22, 2004 (AR) P20040104876

(51) Int. Cl. A61C 17/02

(52) U.S. Cl. 433/80

(57) ABSTRACT

A system of application for an intra-oral medication characterized by An applicating cannula having a suitable angle in order to reach any place with lesion in the mouth, and a container having a gel with adequate bioadhesive drainage to be inserted in periodontal pockets and mucosa folds that is screwed to the cannula. The composition of the gel consisit of chlorhexidine digluconate alone and together with other active principles such as a bisphosphonate, an analgesic or anesthetic substance, antibiotic, antimycotic, an antiviral, steroidal or non-steroidal anti-inflammatory, a coagulant substance or one aimed to modulate local hemosthasis, a cicatrizing substance, among the most outstanding.

### BACKGROUND OF THE INVENTION

1. Technical Field

This invention includes an application system of an intra-oral medication, production of compositions and pharmaceutical containers intended for clinical use by the patient, prescribed by a physician and the dentist, and its use in veterinarian medicine.

The invention as a whole includes the industrial methods for the manufacturing of a gel containing active principles intended for the intra-cavity use, preferably intra-oral, the specific composition of the resulting gel and the design of Local Application System of Intra-Oral Medication (LASIOM) [SALFIO in Spanish].

It does not include the individual therapeutic use of the active principles nor of the other compounds of the gel.

The invention includes the use of the localized application system of other drugs, in which the selective and residual action within a cavity results in a comprehensible advantage.

2. Description of the Prior Art

Numerous medications of intra-oral topical use intended for the prevention and/or treatment of dental gingival, palatal, pharyngeal, etc. conditions are currently used by means of formulas that expose the affected tissues as well as healthy places to the active principles. While in the first ones, therapeutic effects take place, the second ones are exposed to undesirable side effects.

These formulas include liquids dispensed as mouthwashes or spray, tooth pastes, gels or creams, administered in compositions which provide effective concentrations of the active principles.

In general, the affected area of interest is often a small proportion of the total surface exposed to the medication, reason why there is a waste in the performance and consumption of the active principle. In fact the action is topical over the lesion and it is not necessary to expose the whole cavity surface to the active principle.

The quantities used in excess are washed by the saliva and further mouth secretions, being easily swallowed and part of them are absorbed with adverse systemic consequences. In the case of the chlorhexidine, specifically, its sublingual absorption should also be considered.

The local intra-oral use allowing the rational, safe and economical application of the active principles is mostly limited to the application of medications by a professional, without the patient being able to continue with that method outside the dentist's office.

The purpose of oral hygiene is the removal of the bacterial plaque. The bacterial plaque is a biological bio-film similar to those found in nature. In the case of mouth bacterial plaque, it is composed of a matrix of adhesive exoglucanes and bacteria typical of the mouth flora. The growth of this bio-film increases over night, since the saliva flow diminishes allowing in that way the increase of bacterial concentration, the tunneling inside the very same bio-film and the elimination of products inherent to bacterial metabolism of acid pH. Once the food substrate (exo-glucanes) is exhausted, the bio-film comes off colonizing other parts of the oral cavity but leaving the adhesive substrate over the dental surface, which is rapidly recycled with an intake of glucids, the cycle starting over again.

It has been demonstrated since long that the acid metabolic products of the bacterial flora constitute the main cause of dental caries and periodontal disease to which should be added the calculus factor (deposit of calcium carbonate: tartar) on the bio-film, protecting this one from any removal.

The bacterial plaque removal methods are physical and chemical, among the physical methods there is the toothbrush, which is good on accessible dental surfaces while leaving inter-dental areas without possible hygiene, reason for which it was thought that toothpastes would be a good additional adjuvant.

This was not the result since the detergent used in toothpastes has no effect over the superficial tension of the bio-film, the adding of abrasive substances did not solve the removal either and what remained was its cosmetic use as regards dental whitening.

Nowadays xylitol is used, which is an alcohol of vegetal origin that supposedly would diminish the adhesion of plaque, an event having doubtful results depending on the bumpy texture of enamel, protrusion of prosthetic pieces, depth of grooves, etc.

Lastly, soft antiseptics as Gantrez are used, which do not solve the problem either. Other physical methods for plaque removal are the dental floss, dental sticks and inter-dental and tufted brushes, depending on the success of the manual skills of the patient.

Chemical methods include antiseptic solutions, the function of which is to eliminate or limit the growth of mouth bacterial flora or the one that is integrated to the plaque. These antiseptics are sold to be used in the form of mouthwashes, mouth rinses or mouth shower solutions (waterpic).

The first antiseptics were solutions of oxygenated water in concentrations of 5 volumes, currently 12% chlorhexidine or hexetidine solutions are used. The problems arise when proving the adverse effects of these mouthwashes. Oxygenated water, although it has effect on anaerobic flora, it does not eliminate the greatest percentage of the aerobic flora, the effects of hexetidine are not very positive and it needs to be accompanied by aggressive essences such as mint and menthol to disguise the flavor, producing retches and the persistency of the gustative sensation during the consumption of food.

Chlorhexidine is currently available in solutions for mouthwashes, spray, creams or gels for dental brushing and use in trays. Chlorhexidine is the ultimate anti-plaque drug, but the unwanted effects: coloration of teeth, skin flaking in gums and losing of taste sense begin on the fifth day of use. With the purpose of perfecting hygiene, there appeared toothpastes containing chlorhexidine. To allow a use for more extended periods of time without the adverse effects, the concentration of chlorhexidine was reduced, thus failing to comply with its bactericide action. The effectiveness of the product is recognized. However, it is not possible to use it in adequate concentrations for more than 5 to 7 days, due to the numerous side effects that it produces on the surface of tooth, mucosa and tongue. There were reports of stains, discoloration, skin flaking and sensory alterations, among others.

Not long ago, chlorhexidine in the form of gel appeared in the market for brushing or topical application, presenting the same inconveniences (adverse effects). Just like in the case of mouthwashes and colutories, the period of use before unwanted effects show up is short and the consumption of gel is the same as in the mouthwash, causing renal deposits and elimination through feces. Although the chlorhexidine gel reduces great part of ingest, as regards application, it cannot be successfully used in handicapped patients or those with motor deficits, bedridden etc.

The Perio chip is a basis of hard gelatin containing chlorhexidine and which the dentist places inside the periodontal pocket to achieve the elution of the drug in the precise place through the dissolution of the gelatin. Another way to limit the action of the chlorhexidine to precise areas are the varnishes containing this antiseptic, the application is also performed by the dentist and the greatest inconvenience is that the painted area cannot be seen, the solvent of la resin being acetone which causes great irritation on the gum.

Since the current preparations of chlorhexidine do not satisfy the expectations of safety and full efficiency, in the past years compositions with advantages have been patented. For instance: The toothpaste with saccharine and other anti plaque compounds contains chlorhexidine in its composition U.S. Pat. No. 4,614,649 of 1986; the toothpastes with silica particles U.S. Pat. No. 5,612,020 of 1997, U.S. Pat. No. 5,614,176 and U.S. Pat. No. 5,614,177 both of 1997 and the U.S. Pat. No. 5,616,316 of 1997, the composition for oral hygiene with surfactant agents of U.S. Pat. No. 5,695,745 of 1997, the polyurethane devices of U.S. Pat. No. 5,707,366 of 1998, the fiber applying device of U.S. Pat. No. 5,829,976 of 1998, the bi-guanidine toothpaste of U.S. Pat. No. 5,958,381 of 1999, the solid formula of U.S. Pat. No. 5,977,183 of 1999, the watery gel to be used as toothpaste of U.S. Pat. No. 6,017,516 of 2000, the polymer or co-polymer films of U.S. Pat. No. 6,042,818 of 2000, that one of U.S. Pat. No. 6,261,271 of 2001, the bioadhesive sub-micronic emulsion toothpaste of U.S. Pat. No. 6,117,415 of 2000, the dental composition of U.S. Pat. No. 6,143,281 of 2000, the composition for filling dental roots canals of U.S. Pat. No. 6,162,056 of 2000, bio-absorbable microsphere implants of FR 2 778 847 of 1999, the gel system conducted by ultrasound of FR 2 770 402 of 1999, the toothpaste of WO 9 010 434 of 1990 and the antibacterial and antifungical composition of EP 0488 269 of 1990.

There also exist chlorhexidine gels or topical applications for extra-cavity use, such as on skin.

### SUMMARY OF THE INVENTION

Due to the previously mentioned inconveniences in the use of chlorhexidine a system allowing to place the medication only in the area of the lesion to be treated with the medication, is invented, freeing the rest of the mouth soft and hard tissues from the action of the medication which not only would be in excess but its action would also cause unwanted effects in the rest of the mouth cavity with the aggravating factor that the drug is dragged by the saliva leading to its later consumption as in the case of mouthwashes, colutories and pastes or gels for dental brushing.

A gel was invented with that purpose, containing the medication (not toothpaste) having the appropriate concentration, (not diminished to reduce unwanted effects). This gel has the characteristics of being bio-adhesive, with an adequate draining allowing it to penetrate in the typical anatomic mouth spaces and in those generated by gingival pathologies (periodontal pockets).

It is important to emphasize that the draining of this gel allows the entrance in the periodontal pockets, to exert the anti bacterial action of the drug and not to remain as a strange body inside this cavity avoiding discomforts due to distension and biological reactions such as reaction against the strange body (perio chip). With the purpose of placing the gel into the area a cannula was designed with a suitable angle which allows placing the gel in the indicated area whether it is superior, inferior, left or right. This flexible plastic cannula with rubber cap that prevents any possible lesion during its use, may be applied with any hand and an operator can place it in a handicapped person. The gel contains a colorant of translucent color that allows the patient to distinguish the area where it was applied and do not exceed the quantities of the applied gel. The system consists of a multi laminated container carrying the gel (monodose or polidose) preventing dehydration or for the chlorhexidine to get stuck onto the container's walls.

This invention is an intra-oral medication application system of a gel of defined composition that provides extended residual action in the exact place of the intra-oral lesion, accessible through an applicator. In this way, the patient may receive the medication in an effective manner and for more extended periods than with the other non-specific methods. Unlike the other localized systems (microspheres, intra-canal compositions, periochip, varnish) this method may be repeated and used by the same patient.

None of the previously mentioned compositions can be assimilated to this invention since the characteristic of the same is not localized on the lesion and when speaking of specific mechanisms, the composition lacks extended residual action, a surprising fact deriving from the composition and use of the gel used with our method. Nor may it be assume from any of these inventions that the present invention may provide those advantageous properties.

### DESCRIPTION OF THE FIGURES

FIG. 1: Scheme of the container according to this invention. In it, it could be differentiated the application cannula, the container carrying the gel and the cap.

FIG. 2: Size of the metered plastic cap.

FIG. 3: Size of the applicator rubber cap.

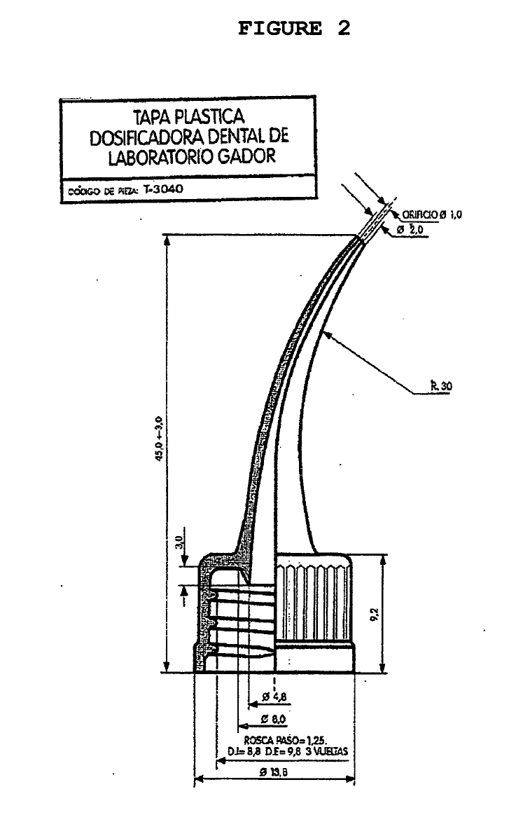

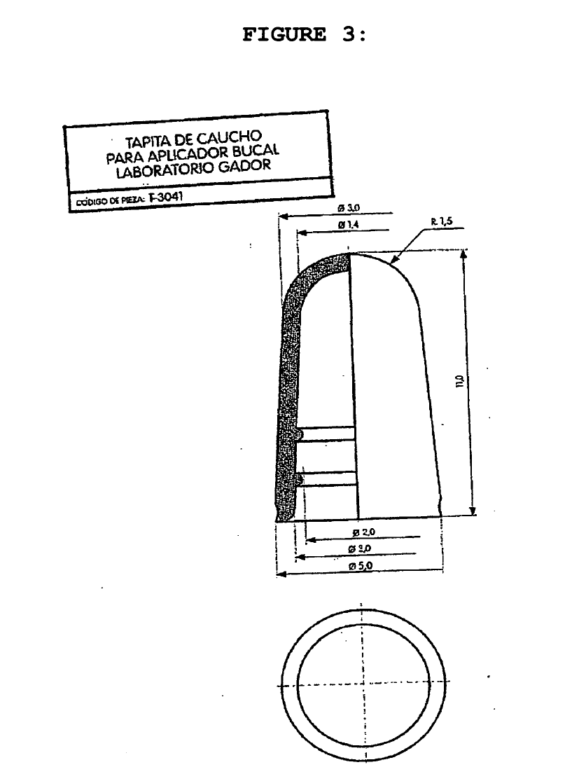

Certainly, when this invention is put into practice, alterations may be introduced as regards certain details of construction and form, which does not mean putting aside the essential principles clearly illustrated in FIGS. 2 and 3.

### DESCRIPTION OF THE INVENTION

With the idea of developing a formula that may allow to exert the antiseptic action of the chlorhexidine in areas of interest within the oral cavity, system of application of an intra-oral medication has been developed, which is characterized by: An applicator cannula having a suitable angle to reach any place with a lesion in the mouth and, acontainer carrying a gel with adequate bioadhesive drainage to be inserted in periodontal pockets and mucosa folds to be screwed onto the cannula.

It has been proved that the said local application is effective and safe, even when administered for periods of time longer than those advisable for mouthwashes (see examples 3 to 5) and that, surprisingly, the preparation remains in the place of the lesion for a longer time than it was expected, as compared to mouthwashes (see example 6).

The shortest exposure to the active principle and relative resistance to the washing of mouth liquids makes the chlorhexidine pass in minor proportions to the digestive system, thus avoiding side effects (example 7).

As a consequence, it was possible to develop a preparation with more antiseptic power or having smaller concentrations, thus optimizing the tolerance to the product.

Another preferred feature of this invention is that the cannula has transparent plastic materials to see the passing of the gel. Moreover, the cannula is curved and has a cap. Said cannula may be screwed to ensure closure to the container and said cannula is slotted with a grip to facilitate its closure. The material of said cannula is transparent Randon propylene and the material of the cap is natural rubber.

Another preferred feature of this invention refers to a gel contained in the container consisting of chlorhexidine digluconate. It also may contain propylenglycol, a blue colorant, hydroxypropylcellulose, purified water and pharmaceutically acceptable excipients.

Said gel is non-toxic, bioadhesive and having a blue colorant. It may contain flavors and essences. The blue colorant may be Blue D Patent VE-131.

Another preferred feature of this invention is the preparation procedure of the gel used in said application system. Said procedure includes the following steps:
Load in a reactor of adequate capacity the purified water, initiate the agitation and warm up until boiling point for a period of five minutes,
cool the purified water to a temperature of 80 to 85° C., with constant agitation,
unload from the reactor part of the purified water from the previous step to a stainless steel receptacle previously sanitized and furnished with a cap,
keeping the temperature within the range of 80 to 85° C., incorporate to the reactor hydroxypropylcellulose with agitation,
continue the agitation and apply homogenizing turbine to disperse the polymer,
initiate cooling to 60 to 65° C.,
keep the agitation; incorporate to the reactor the 20% chlorhexidine digluconate.

Rinse the receptacle with the purified water reserved in the first step,
in a receptacle with adequate capacity, prepare a solution with the previous raw materials, using for that purpose a fraction of the purified water reserved in the first step,
add the previous solution to the reactor with agitation,
Cool up to a temperature of 40° C., applying vacuum and keeping a soft agitation,
Leave the mixture till the following day to complete the hydration of the polymer, with constant vacuum.

Another preferred feature of this invention is that one in which the carrying container is a tube or multilaminated container. Also one in which the cannula has an orifice of 1.5 to 2.9 mm.

Another form of carrying out this invention, is a system of application of an intra-oral medication according to clauses 1 and 2 characterized by the fact that it also contains as active principle a bisphosphonate, of Disodium pamidronate type, Monosodium alendronate, Monosodium olpadronate, amino alendronate, amino dimethyl alendronate, amino pamidronate, Neridronate, etidronate, chlodronate, ibadronate, incadronate, Risedronate, zoledronate and tiludronate. Preferably, when the bisphosphonate is Pamidronate.

A further active principle of the application system is an analgesic or anesthetic substance. It also may contain as active principle metronidazole, hyaluronic acid, acetylsilaxates, bromocresole. Those containing metronidazole are preferred. They also may contain as active principle an antibiotic, antimycotic, an antiviral, steroidal or non-steroidal anti-inflammatory, a coagulant substance or one aimed to modulate the local hemosthasia, a cicatrizing substance.

As “antibiotic” is understood: gentamicin, chloranphenicol, cephalosporine (ceftizoxime), penicillin (amoxicillin), macrolide (azithromycin, erythromycin), and tetracycline. As “antimycotic” amphotericin B, fluconazole. As “antiviral” didanosine, lamivudine, stavudine, zidovudine, indinavir, ritonavir. As “steroidal anti-inflammatory” meprednisone. As “non steroidal anti-inflammatory” sodium diclofenac, indomethacin, flurbiprofen, acetylsalicylic acid. As “coagulant substance or one aimed to modulate the local hemosthasia” factor VIII, thrombin.

The application system of an intra-oral medication may contain as active principle a cement or a substance for bone filling of the methyl metacrilate type.

The application system of this request is directed to maintain the oral hygiene, control of dental plaque and infections in orthodontia and orthopedics, in periodontopathies, in pre and post-surgery, for implants and prostheses, in mouth breathing, for epileptics, handicapped or people with motor alterations, bedridden patients or those in intensive care, to treat imperfect osteogenesis, during pregnancy, xerostomy, for pyogenic pathologies, leukemia, aphthosis, for gingival enlargements, inmunosupressed patients, patients with respirator, AIDS patients, bedridden patients having manual incapacity, in veterinary.

This composition of larger residual action, administered through an adequate applicator for mouth intra-cavity use, is novel and constitutes the typical model of the invention. Although the invention is not limited to the examples provided herein and to the preparations that may contain other drugs of intra-cavity use, and to the fact that the gel of essentially similar composition applied through an applicator allows a more persistent effect, it also must be considered within the spirit of this invention.

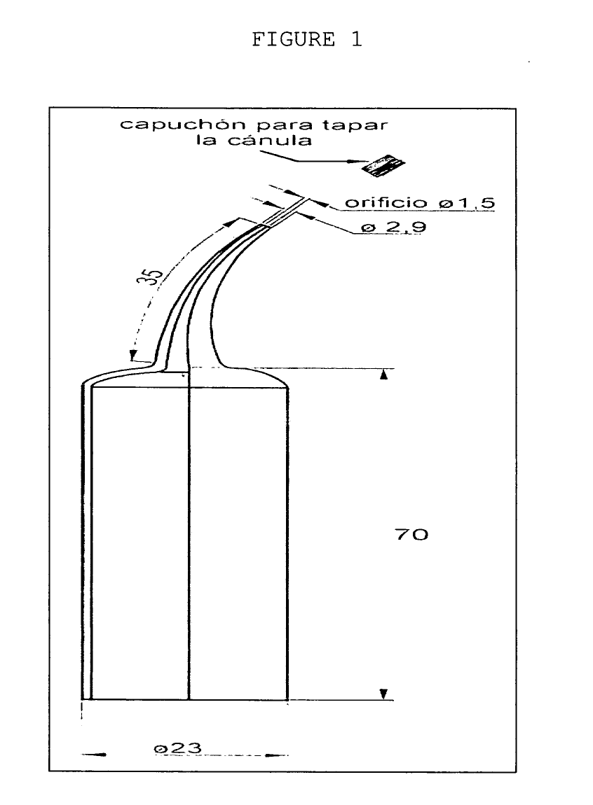

By “adequate cannula” is understood any curved position of the cannula that may allow an easy and quick access to the area with lesion in the mouth. Preferably, those complying with the scheme provided in FIG. 1 are selected.

By “medication” is understood any preparation or pharmaceutical product used for the prevention, diagnosis and/or treatment of a disease or pathological condition, or to modify physiological systems in benefit of the person to whom it is administered (Definition according to what it is set forth in Decree 150/92 B.O. 23 Jan. 1992).

### EXAMPLES

Herein enclosed is a description of a model of the invention as regards its composition, applicators, uses and demonstrations of persistency and selectivity.

### Example 3.1

### Composition of a Chlorhexidine Gel of Persistent Residual Action

Chlorhexidine digluconate 20% . . . 0.63%*
Propylenglycol . . . 20.00%
Blue D Patent VE-131 . . . 0.0016%
Hidroxypropylcellulose (Klucel HF Pharm) . . . 2.5%
Purified water . . . 76.8684%
   (*) Takes in account 5% of excess.
   Manufacturing Technique:

1. Load in a reactor of adequate capacity the purified water, start agitating and warm up until achieving the boiling point for a period of five minutes,

2. cool the purified water to a temperature of 80 to 85° C., with constant agitation,

3. unload from the reactor part of the purified water from the previous step to a stainless steel receptacle previously sanitized and furnished with a cap,

4. keeping the temperature within the range of 80 to 85° C., incorporate to the reactor hydroxypropylcellulose with agitation,

5. continue the agitation and apply homogenizing turbine to disperse the polymer,

6. initiate cooling to 60 to 65° C.,

7. keep the agitation, incorporate to the reactor the 20% chlorhexidine digluconate Rinse the receptacle with the purified water reserved in the first step,

8. in a receptacle with adequate capacity, prepare a solution with the previous raw materials, using for that purpose a fraction of the purified water reserved in the first step,

9. add the previous solution to the reactor with agitation,

10. Cool to a temperature of 40° C., applying vacuum and keeping a soft agitation,

11. Leave the mixture till the following day to complete the hydration of the polymer, with constant vacuum.
Aspect: Homogeneous gel, shiny, of blue color similar to Pantone color guide (edition 18) 299C.
Viscosity: 25.000-70.000 cps (Brookfield RVF: needle N^{o}6-10 rpm).
pH: 5,5-6,5 (3% suspension in distilled water).

12. Unload the product in a receptacle of adequate capacity properly capped and identified.

Fitting-out:

Fraction the product in syringes of high density polyethylene with curved ends, at a ratio of 3 g of gel per syringe. Fit out each syringe in a polyethylene bag and seal properly.

Radiation of Product:

Submit the fitted-out product to a dose of gamma radiation between 1,5 and 3 kg.

Other examples of composition would be:
Chlorhexidine digluconate 20% . . . 0.63%*
Propylenglycol . . . 21.00%
Blue D Patent VE-131 . . . 0.0015%
Hydroxypropylcellulose (Klucel HF Pharm) . . . 1.5%
Purified water . . . 76.8685%
   (*) Takes into account 5% of excess.
Chlorhexidine digluconate 20% . . . 0.70%*
Propylenglycol . . . 18.50%
Blue D Patent VE-131 . . . 0.0020%
Hydroxypropylcellulose (Klucel HF Pharm) . . . 3.5%
Purified water . . . 77.2980%
   (*) Takes into account 5% of excess.

### Example 3.2

### (With Graphics) Model of Applicators for the Intra-cavity (Intra-oral) Use of the Chlorhexidine Gel. See FIG. 1

### Example 3.3

Description of the Effects of the Invention Set Forth in the Examples 3.1 and 3.2 in Periodontics

[image]

The application of the invention in the treatment of patients having periodontal disease: the test consisted in the application of gel containing chlorhexidine with the applicator, which was placed on the lesion.

One hundred and seven patients having periodontal disease, men and women whose age ranged between 18 and 60 years, received a basic periodontal treatment consisting in scaling and curettage of the periodontal pockets during the treatment and, once it was finished, the gel was applied with the applicator three times a day, for a period of three months, not appearing in any of the cases unwanted effects nor typical adverse reactions due to the use of chlorhexidine at the end of one week.

The status of the patient, according to the gum bleeding and bacterial plaque tests, was taken as a reference to evaluate the results. The treatment being finished in four weeks, an evaluation was carried out once again according to the previously mentioned tests; the results obtained through this test were as follows: classified with the grade Very good, two points of variation; in the test grade Good, one point of variation, with Regular variation in only one of the tests and without effect and without variation in none of the tests. Results over 147 patients: 105 Very Good; 42 Good.

### Example 3.4

### Description of the Effects of the Invention Set Forth in the Examples 3.1 and 3.2 in Handicapped People

The application of the invention in handicapped patients has a double purpose: to assess the effectiveness of the invention as regards convenience and therapeutic action, while the other purpose is to assess the possibility of administering a bacteriostatic antiseptic to patients to whom it cannot be administered through any other pharmaceutical form (mouthwash).

This test was carried out on a group formed by 50 patients, men and women, whose age ranged between 12 and 30 years, all of them being unable to use colutory mouthwashes or any other general pharmaceutical form: handicapped patients are included in this group.

### Example 3.5

### Description of the Effects of the Invention Set Forth in Examples 3.1 and 3.2 in General Dentistry

Included in this item were different pathologies (gingivitis, lesions of soft tissues, surgeries, alveolitis, lesions in HIV patients and leukemia). Over a total of 147 men and women, whose ages ranged between 20 and 60 years, the product was used with an application twice a day over 2 weeks. The results were: 130 Very Good, 13 Good and 4 Regular.

### Example 3.6

### Description of the Greatest Persistency of Chlorhexidine In Situ Administered Through the Invention Set Forth in the Examples 3.1 and 3.2

“in vivo” Tests:

Using a chlorhexidine gel marked with technetium 99 and through the applicator, it is placed on an area of the mouth. Using a gamma camera of a Wellcounter type, images time 0 of the mouth cavity are obtained and after several mouth washes with water, the persistency of the activity is observed in the mouth cavity, demonstrating the adherence of the gel.

[image]

[image]

“In Vitro” Tests:

Two dental pieces are immersed during 15 minutes, one in chlorhexidine gel with technetium 99 and the other one in the chlorhexidine mouthwash marked with technetium 99.

Later on, they were rinsed in a water current over 10 minutes and measured with an alpha nuclear activimeter, the gel measuring 151 μci., while the mouthwash measures 27 μci. This shows the persistency of activity of the drug marked in the gel and not in the mouthwash.

Later on, these two pieces are placed on a Kodak x-ray film and developed after 30 minutes of exposure, the area corresponding to the gel showing a greater fogging of the film, consistent with a major persistency of the marked chlorhexidine.

[image]

### Example 3.7

### Description of the Degree of Extra-oral Digestive Distribution of the Marked Chlorhexidine, Administered Through Mouthwashes or Through the Invention Described in Examples 3.1 and 3.2

Using the chlorhexidine mouthwash marked with technetium 99 and using a Siemens gamma camera, Wellcounter model, to time 0, a mouthwash is performed in front of the camera and images were obtained of how the marked mouthwash is swallowed and how the activity in the, mouth diminishes, while increasing in the digestive tract, stomach and inner.

The same test is made with the chlorhexidine gel, being observed a greatest permanency in the mouth, less activity in the stomach. The results are shown in the following chart:

[image]

[image]

In the figure below, appears the image of the mouth with mouthwash and on the right the activity of the stomach in increasing periods of time from upside downwards. As the activity in the mouth decreases, the one in the stomach increases, which demonstrates the ingest of the colutory marked with meta stable Technetium 99. In the first image on the left there appears a compact stain, while in the second one the residues remain in the mouth; in the third one there is no activity in the mouth. At the same time, in the images on the right an increase of activity is observed not only in the stomach but also in the intestine.

[image]

[image]

1-34. (canceled)

35. A system for applying an intra-oral medication comprising:
an applicator cannula having an angle adapted to reach a place with lesion in a mouth,
a container screwed into the cannula, and
a gel with a bio-adhesive drainage, wherein the gel is contained in the container, wherein the gel is inserted into periodontal pockets and sub-dental mucosa folds in the mouth.

36. The system according to clause 35, wherein the cannula is made of a transparent plastic material to see the passing of the gel.

37. The system according to claim 35, wherein the cannula is curved and has a cap.

38. The system according to claim 37, wherein the cannula is slotted with a grip to facilitate its closing.

39. The system according claim 36, wherein the material of the said cannula is Randon propylene.

40. The system according to claim 37, wherein the material of the cap is natural rubber, being the active principle an antifungical or antiviral substance.

41. The system according to claim 35, wherein the gel contained in the container has chlorhexidine digluconate.

42. The system according to claim 41, wherein the gel further comprises at least one of propylenglycol, a blue colorant, hydroxypropylcellulose, purified water, pharmaceutically acceptable excipients, or combinations thereof.

43. The system according to claim 35, wherein the gel is non-toxic, bioadhesive and has a blue colorant.

44. The system according to claim 43, wherein the gel further comprises at least one of flavors and essences.

45. The system according to claim 35, wherein the gel comprises:
chlorhexidine digluconate 20%,
propylenglycol,
Blue D Patent VE-131,
hydroxypropylcellulose (Klucel HF Pharm), and
purified water.

46. The system according to claim 45, wherein the gel is prepared by:
a) loading in a reactor the purified water, agitating, and warming up until a boiling point for a period of five minutes,
b) cooling the purified water to a temperature of 80 to 85° C., with constant agitation,
c) unloading from the reactor a portion of the purified water from the previous step to a stainless steel receptacle previously sanitized and furnished with a cap,
d) keeping the temperature within the range of 80 to 85° C., incorporating to the reactor hydroxypropylcellulose with agitation,
e) continuing the agitation and applying homogenizing turbine to disperse the polymer,
f) initiating cooling to 60 to 65° C.,
g) keeping the agitation, incorporating to the reactor the 20% chlorhexidine digluconate,
h) rinsing the receptacle with the purified water reserved in the first step,
i) preparing in a second receptacle a solution with the previous raw materials, using for that purpose a fraction of the purified water reserved in the first step,
j) adding the previous solution to the reactor with agitation,
k) cooling to a temperature of 40° C., applying vacuum and keeping a soft agitation,
l) leaving the mixture till the following day to complete the hydration of the polymer, with constant vacuum.

47. The system according to claim 46, wherein the carrying container is a tube or multilaminated receptacle.

48. The system according to claim 35, wherein the cannula has an orifice of 1.5 to 2.9 mm.

48. The system according to claim 35, wherein the gel has as active principle a bisphosphonate, particularly Disodium Pamidronate, Monosodium alendronate, Monosodium olpadronate, amino alendronate, amino dimethyl alendronate, amino pamidronate, Neridronate, etidronate, chlodronate, ibadronate, incadronate, Risedronate, zoledronate, analgesic, anesthetic substance, tiludronate, or metronidazole, hyaluronic acid, acetilsilaxates, bromocresole, antibiotic, antimycotic, an antiviral, steroidal or non steroidal anti-inflammatory, a coagulant substance or one aimed to modulate the local hemosthasia, or a cicatrizing substance.

49. The system according to claim 48, wherein the active principle is an antibiotic selected from gentamicin, chloranphenicol, cephalosporine (ceftizoxime), peniciline (amoxicillin), macrolide (azithromycin, erythromycin), tetracycline.

50. The system according to claim 48, wherein the active principle is an antimycotic selected from amphotericin B, fluconazole.

51. The system according to claim 48, wherein the active principle is an antiviral selected from didanosine, lamivudine, stavudine, zidovudine, indinavir, ritonavir.

52. The system according to claim 48, wherein the active principle is a steroidal anti-inflammatory selected from meprednisone.

53. The system according to claim 48, wherein the active principle is a non steroidal anti-inflammatory selected from sodium diclofenac, indomethacin, flurbiprofen, acetylsalicylic acid.

54. The system according to claim 48, wherein the active principle is a coagulant substance or one aimed to modulate the local hemosthasia selected from factor VIII, or thrombin.

55. The system according to claim 48, wherein the active principle is a cement or a bone filling substance of the methyl metacrilate type.
